(19) United States
(12) Patent Application Publication
(10) Pub. No.: US 2024/0367076 A1
(43) Pub. Date: Nov. 7, 2024

(54) LAMINATED SHEET, CYLINDRICAL FILTER ELEMENT, AND FILTRATION KIT USED TO PERFORM WATER FILTRATION

(71) Applicant: Solventum Intellectual Properties Company, Maplewood, MN (US)

(72) Inventors: Guangming GONG, Shanghai (CN); Shengguang QI, Guangzhou (CN); Guihe WANG, Shanghai (CN); Xiang GAO, Shanghai (CN); Saurabh BATRA, Minneapolis, MN (US); Majid ENTEZARIAN, Glastonbury, CT (US); Chuntao CAO, Woodbury, MN (US)

(21) Appl. No.: 18/255,692

(22) PCT Filed: Dec. 2, 2021
(86) PCT No.: PCT/IB2021/061247

§ 371 Date: Jun. 2, 2023

(30) Foreign Application Priority Data
Dec. 9, 2020 (CN) 202011431711.6

(51) Int. Cl. B01D 39/16; B01D 29/11; C02F 1/00

(52) U.S. Cl. CPC B01D 39/163; B01D 29/111; C02F 1/001; B01D 2239/0216; B01D 2239/025; B01D 2239/0636; B01D 2239/0654; B01D 2239/1208; B01D 2239/1216; B01D 2239/1233; B01D 2239/1291

(57) ABSTRACT

The present invention provides a laminated sheet, a cylindrical filter element, and a filtration kit that are used to perform water filtration. Specifically, the laminated sheet used to perform water filtration includes: a pre-filtration layer, the pre-filtration layer including a first fiber having a diameter within a range of 1-5 μm and a second fiber having a diameter within a range of 200-900 nm, and the pre-filtration layer having a pore diameter within a range of 0.2-1 μm; and a fine filtration layer, the fine filtration layer having a pore diameter within a range of 0.02-0.5 μm, wherein the pore diameter of the pre-filtration layer is greater than the pore diameter of the fine filtration layer. The laminated sheet used to perform water filtration and the cylindrical filter element and the filtration kit including the same according to the technical solution of the present invention have an extremely small pressure difference, high filtration efficiency, and a long service life.

### TECHNICAL FIELD

The present invention relates to the technical field of water treatment, and specifically, the present invention provides a laminated sheet, a cylindrical filter element, and a filtration kit that are used to perform water filtration.

### BACKGROUND

With gradual improvements in living standards, people have increasingly higher requirements for water quality. Currently, the demand for filters for industrial and domestic water treatment is increasing. Commercially available filters used to perform water treatment mainly have fibrous filter membranes made from various polymer materials (including polypropylene, polyethersulfone, nylon, etc.) For a melt-blown micro fiber (BMF) filter membrane made from a hydrophobic polypropylene material, when high filtration efficiency is required, fine polypropylene fibers having a diameter of about 2-5 μm needs to be used to form a filter membrane by means of a hot calendering process so as to reduce the pore diameter of the filter membrane so as to achieve a desired filtration level (for example, less than 0.5 μm). However, due to the inherent hydrophobicity of the polypropylene material and a high-density fiber web structure of the filter membrane caused by the hot calendering process, the BMF filter membrane generally has the disadvantage of having a large pressure difference. On the other hand, although materials such as polyethersulfone and nylon have a small pressure difference when used as a microfiltration medium, non-woven fabrics made from these materials are expensive compared to non-woven fabrics made from common materials. In addition, during use of these filter membranes, impurities in water are prone to be quickly deposited on a surface of the filter membrane to form a filter cake, resulting in a reduced service life of the filter membrane. Therefore, the filter membrane needs to be backflushed frequently.

Currently, the industry has huge demand for filtration materials requiring a simple manufacturing process and having low costs, high filtration efficiency, and a long service life. Therefore, it is of great significance to develop a filtration material having a small pressure difference, high filtration efficiency, and a long service life.

### SUMMARY

In view of the aforementioned technical problem, the objective of the present invention is to provide a laminated sheet, a cylindrical filter element, and a filtration kit that are used to perform water filtration. The laminated sheet used to perform water filtration and the cylindrical filter element and the filtration kit comprising the same according to the technical solution of the present invention have an extremely small pressure difference, high filtration efficiency, and a long service life.

The inventors of the present invention have conducted intensive and detailed research to obtain the present invention.

According to an aspect of the present invention, a laminated sheet used to perform water filtration is provided, the laminated sheet comprising:
a pre-filtration layer, the pre-filtration layer comprising a first fiber having a diameter within a range of 1-5 μm and a second fiber having a diameter within a range of 200-900 nm, and the pre-filtration layer having a pore diameter within a range of 0.2-1 μm; and
a fine filtration layer, the fine filtration layer having a pore diameter within a range of 0.02-0.5 μm, wherein
the pore diameter of the pre-filtration layer is greater than the pore diameter of the fine filtration layer.

According to another aspect of the present invention, a filter element used to perform water filtration is provided, the filter element being formed by rolling a laminated sheet into a shape of a cylinder, the laminated sheet comprising:
a pre-filtration layer, the pre-filtration layer comprising a first fiber having a diameter within a range of 1-5 μm and a second fiber having a diameter within a range of 200-900 nm, and the pre-filtration layer having a pore diameter within a range of 0.2-1 μm;
a fine filtration layer, the fine filtration layer having a pore diameter within a range of 0.02-0.5 μm; and
a support layer, the support layer being on a side of the fine filtration layer disposed away from the pre-filtration layer,
wherein the pore diameter of the pre-filtration layer is greater than the pore diameter of the fine filtration layer, the fine filtration layer is located on an inner side of the cylinder, and the support layer is located on an outer side of the cylinder.

According to still another aspect of the present invention, a cylindrical filter element used to perform water filtration is provided, the cylindrical filter element, sequentially from the inside to the outside, comprising:
a cylindrical inner core;
a cylindrical intermediate core, the cylindrical intermediate core being formed by rolling the above laminated sheet, wherein: when the support layer is present, the pre-filtration layer is located on an outer side of the cylindrical intermediate core, and the support layer is located on an inner side of the cylindrical intermediate core; or, when the support layer is absent, the pre-filtration layer is located on the outer side of the cylindrical intermediate core, and the fine filtration layer is located on the inner side of the cylindrical intermediate core; and
a cylindrical outer core.

According to yet another aspect of the present invention, a filtration kit used to perform water filtration is provided, wherein the filtration kit accommodates the above cylindrical filter element used to perform water filtration.

Compared with the existing techniques in the art, the present invention has the following advantages: the laminated sheet and the cylindrical filter element and the filtration kit comprising the same that are used to perform water filtration according to the technical solution of the present invention have an extremely small pressure difference, high filtration efficiency, and a long service life.

### BRIEF DESCRIPTION OF THE DRAWINGS

The accompanying drawings, which are incorporated herein and constitute part of this specification, illustrate exemplary embodiments of the present invention, and, together with the general description provided above and the detailed description provided below, serve to explain the features of the present invention.

FIG. 1 shows a schematic cross-sectional view of a laminated sheet used to perform water filtration having a two-layer structure according to an embodiment of the present invention;

FIG. 2 shows a schematic cross-sectional view of a laminated sheet used to perform water filtration having a three-layer structure according to another embodiment of the present invention;

FIG. 3 shows a schematic cross-sectional view of a cylindrical filter element having a collapsible structure according to still another embodiment of the present invention;

FIG. 4 shows a schematic cross-sectional view of a cylindrical filter element having an intercalation structure according to yet another embodiment of the present invention;

FIG. 5 shows a scanning electron microscope (SEM) image of fibers of a pre-filtration layer prepared in embodiments 1-2 and 4, the image showing the morphology and diameter distribution thereof;

FIG. 6 shows a scanning electron microscope image of fibers of a fine filtration layer prepared in embodiments 1-3, the image showing the morphology and diameter distribution thereof;

FIG. 7 shows a scanning electron microscope image of fibers of a fine filtration layer prepared in embodiment 4, the image showing the morphology and diameter distribution thereof;

FIG. 8 shows a scanning electron microscope image of a PES filter membrane having a porous membrane structure and used in comparative example 3, the image showing the morphology and pore diameter and distribution thereof;

FIG. 9 shows analysis on filtration efficiency of a nanofiber composite filter membrane prepared in embodiment 4 on ultrafine particles smaller than 0.1 μm;

FIG. 10 shows performance differences between embodiments and comparative examples with respect to liquid filtration, including filtration efficiency and a pressure difference rise; and

FIG. 11 shows pressure differences of filtration materials having different structures at different flow rates in embodiments and comparative examples.

### DETAILED DESCRIPTION

It is to be understood that a person skilled in the art can envisage other various embodiments according to teachings in this description, and can make modifications thereto without departing from the scope or spirit of the present disclosure. Therefore, the following particular embodiments are not restrictive in meaning.

All figures for denoting characteristic dimensions, quantities and physicochemical properties used in this specification and claims are to be understood as modified by a term “about” in all situations, unless indicated otherwise. Therefore, unless stated conversely, parameters in numerical values listed in the above description and the claims are all approximate values, and a person skilled in the art is capable of seeking to obtain desired properties by taking advantage of contents of the teachings disclosed herein, and changing these approximate values appropriately. The use of a numerical range represented by end points includes all figures within the range and any range within the range, for example, 1 to 5 includes 1, 1.1, 1.3, 1.5, 2, 2.75, 3, 3.80, 4, 5, and the like.

The inventors of the present invention found that during water filtration performed by means of a filtration material, impurities in water are prone to be quickly deposited on a surface of the filtration material to form a filter cake, and a densely packed filter cake layer increases a pressure difference of the filtration material, resulting in a reduced service life thereof. In actual operation, the filtration material needs to be replaced or backflushed frequently. The technical solution of the present invention provides a pre-filtration layer/fine filtration layer composite laminated sheet used to perform water filtration. A pre-filtration layer having a specific structure and located on a water inlet side of a filtration material can serve as a particle retention layer to uniformly and effectively retain relatively large particles in a fluid to prevent the same from being deposited on a surface of a fine filtration layer therebelow so as to prevent formation of a dense filter cake layer to a maximum degree, so that a service life of a filtration medium is extended. This is mainly because even distribution of sub-micron fibers (200-900 nm) in a main body of a non-woven structure formed by micron fibers (1-5 μm) increases the porosity and the specific surface area of the pre-filtration layer, so that more particles can be retained, and the particles are prevented from being directly deposited on the surface of the fine filtration layer. In addition, the fine filtration layer having the specific structure can remove minute impurities in water, so that excellent filtration efficiency is achieved. Specifically, according to the technical solution of the present invention, a pre-filtration layer/fine filtration layer composite laminated sheet is provided. In the composite structure, a pre-filtration layer and a fine filtration layer are used together. The composite laminated sheet medium for filtration has a good particle retention capability, an extended service life, and high filtration efficiency.

Specifically, according to an aspect of the present invention, a laminated sheet used to perform water filtration is provided, the laminated sheet including:
a pre-filtration layer, the pre-filtration layer including a first fiber having a diameter within a range of 1-5 μm and a second fiber having a diameter within a range of 200-900 nm, and the pre-filtration layer having a pore diameter within a range of 0.2-1 μm; and
a fine filtration layer, the fine filtration layer has a pore diameter within a range of 0.02-0.5 μm, wherein
the pore diameter of the pre-filtration layer is greater than the pore diameter of the fine filtration layer.

According to the above technical solution of the present invention, the pre-filtration layer serves as a particle retention layer, and is located on the water inlet side of the laminated sheet used to perform water filtration. The function of the pre-filtration layer is to firstly capture relatively large particles in the water that may form a filter cake on the surface of the filtration material during water filtration, so that formation of a dense filter cake layer that may cause a pressure difference between two sides of the filtration medium to increase is slowed down. The pre-filtration layer includes a composite structure including a micron fiber (the first fiber) and a sub-micron fiber (the second fiber). The sub-micron fiber (the second fiber) is relatively uniformly distributed in the main body of the non-woven structure formed by the micron fiber (the first fiber) to form a composite material having specific pores. The first fiber has a diameter within a range of 1-5 μm, preferably within a range of 2-3 μm. In addition, the second fiber has a diameter within a range of 200-900 nm, preferably within a range of 300-600 nm. No particular limitation is set to the length of the first fiber and the length of the second fiber as long as the first fiber and the second fiber can be effectively combined and form a cross network structure in a combination process (for example, melt blowing, carding, air laying, wet laying, and electrostatic spinning). In order to achieve a good filtration effect and excellent particle retention properties, the pre-filtration layer has a pore diameter within a range of 0.2-1 μm, preferably within a range of 0.4-0.8 μm.

The porosity of the filtration material has a significant effect on filtration efficiency. If a porosity is overly small, then filtration resistance encountered by water is relatively large. On the contrary, if a porosity is overly large, then mechanical properties (strength, toughness, etc.) of the filtration material may be reduced. According to the technical solution of the present invention, porosity refers to a ratio of the total volume of all of the pores in the filtration material to the total volume of the filtration material. According to a preferred embodiment of the present invention, in order to achieve a good filtration effect and excellent particle retention properties, the pre-filtration layer has a porosity within a range of 30-90%, preferably within a range of 50-85%. In addition, the fine filtration layer has a porosity of 50-95%.

According to some preferred embodiments of the present invention, with the total weight of the pre-filtration layer being 100 wt %, the first fiber accounts for 50-99 wt %, preferably 65-75 wt %, and the second fiber accounts for 1-50 wt %, preferably 25-35 wt %. According to some specific embodiments of the present invention, a mixed fiber assembly of the first fiber and the second fiber having the same fiber density is acquired by subjecting a resin material to melt extrusion. The weight percent of the first fiber and the weight percent of the second fiber are calculated by using a scanning electron microscope (SEM) to count the numbers of strands and measure the diameters of the first fiber and the second fiber in the mixed fiber assembly.

According to some preferred embodiments of the present invention, the pre-filtration layer has a thickness within a range of 100-5000 μm, preferably within a range of 200-1000 μm, and the pre-filtration layer has a grammage within a range of 10-120 g/m², preferably within a range of 15-45 g/m².

No particular limitation is set to the specific material of the first fiber and the second fiber that can be used in the present invention, and the material can be appropriately selected from fibrous materials commonly used as filtration materials in the art. Preferably, the first fiber and the second fiber are prepared from materials respectively and independently selected from polyolefin, polyether, polyamide, polysulfone, polyester, fluoropolymer, polyacrylonitrile, polyurethane, polyvinyl alcohol, cellulose acetate, and a mixture or copolymer thereof. Specifically, each of the first fiber and the second fiber is independently selected from polyolefin fiber (for example, polyethylene fiber, polypropylene fiber, polystyrene fiber, etc.), polyether fiber (polyphenylene sulfide fiber, polyethylene oxide fiber, etc.), polyamide fiber (nylon 6 fiber, nylon 66 fiber, polyimide fiber, etc.), polysulfone fiber (polyethersulfone fiber, etc.), polyester fiber (polyethylene terephthalate fiber, polybutylene terephthalate fiber, etc.), fluoropolymer fiber (polyvinylidene fluoride fiber, polytetrafluoroethylene fiber, vinylidene fluoride-hexafluoropropylene copolymer fiber), polyacrylonitrile fiber, polyurethane fiber, polyvinyl alcohol fiber, etc.

Preferably, the first fiber and the second fiber are hydrophilic fibers. A material layer consisting of hydrophilic fibers causes low resistance encountered by a water flow, and the flow rate of water is larger at the same pressure.

No particular limitation is set to a specific method for forming the pre-filtration layer, and a specific process commonly used in the art to form a fibrous layer (or mat) can be appropriately selected. Preferably, the pre-filtration layer is prepared by means of one of or a combination of the following processes: melt blowing, carding, air laying, wet laying, and electrostatic spinning. Preferably, the first fiber and the second fiber are used to form the pre-filtration layer by means of a melt blowing process.

The laminated sheet used to perform water filtration according to the present invention needs to further include a fine filtration layer in addition to the pre-filtration layer described in detail above. The fine filtration layer is used to perform fine filtration on the water so as to achieve a good filtration effect. In order to achieve high filtration efficiency, the fine filtration layer has a pore diameter within a range of 0.02-0.5 μm, preferably within a range of 0.04-0.2 μm. Regarding specific selections of the pore diameter of the pre-filtration layer and the pore diameter of the fine filtration layer, in order to achieve the technical effect of retaining particles in the pre-filtration layer and performing effective filtration in the fine filtration layer, the pore diameter of the pre-filtration layer needs to be greater than the pore diameter of the fine filtration layer.

According to some preferred embodiments of the present invention, the fine filtration layer includes a third fiber. The third fiber has a diameter within a range of 10-200 nm, preferably within a range of 60-150 nm.

No particular limitation is set to the specific material of the third fiber that can be used in the present invention, and the material can be appropriately selected from fibrous materials commonly used as filtration materials in the art. Preferably, the material of the third fiber is selected from polyolefin, polyether, polyamide, polysulfone, polyester, fluoropolymer, polyacrylonitrile, polyurethane, polyvinyl alcohol, cellulose acetate, and a mixture or copolymer thereof. Specifically, the third fiber is selected from polyolefin fiber (for example, polyethylene fiber, polypropylene fiber, polystyrene fiber, etc.), polyether fiber (polyphenylene sulfide fiber, polyethylene oxide fiber, etc.), polyamide fiber (nylon 6 fiber, nylon 66 fiber, polyimide fiber, etc.), polysulfone fiber (polyethersulfone fiber, etc.), polyester fiber (polyethylene terephthalate fiber, polybutylene terephthalate fiber, etc.), fluoropolymer fiber (polyvinylidene fluoride fiber, polytetrafluoroethylene fiber, vinylidene fluoride-hexafluoropropylene copolymer fiber), polyacrylonitrile fiber, polyurethane fiber, polyvinyl alcohol fiber, etc.

Preferably, the third fiber is a hydrophilic fiber. A material layer consisting of hydrophilic fibers causes low resistance encountered by a water flow, and the flow rate of water is larger at the same pressure.

Preferably, the fine filtration layer has a thickness within a range of 5-50 μm, preferably within a range of 10-25 μm. The fine filtration layer has a grammage within a range of 0.5-5 g/m², preferably within a range of 1.0-2.5 g/m².

According to the technical solution of the present invention, the pre-filtration layer and the fine filtration layer in the laminated sheet used to perform water filtration contact and fit to each other. No particular limitation is set to the specific type of a process for joining the pre-filtration layer to the fine filtration layer as long as the joining process does not result in that an isolation structure hindering water permeation is formed between the pre-filtration layer and the fine filtration layer. Preferably, the pre-filtration layer and the fine filtration layer are joined by means of one of or a combination of the following processes: hot calendering, ultrasonic welding, and bonding. Preferably, the pre-filtration layer and the fine filtration layer are joined by means of a hot calendering process.

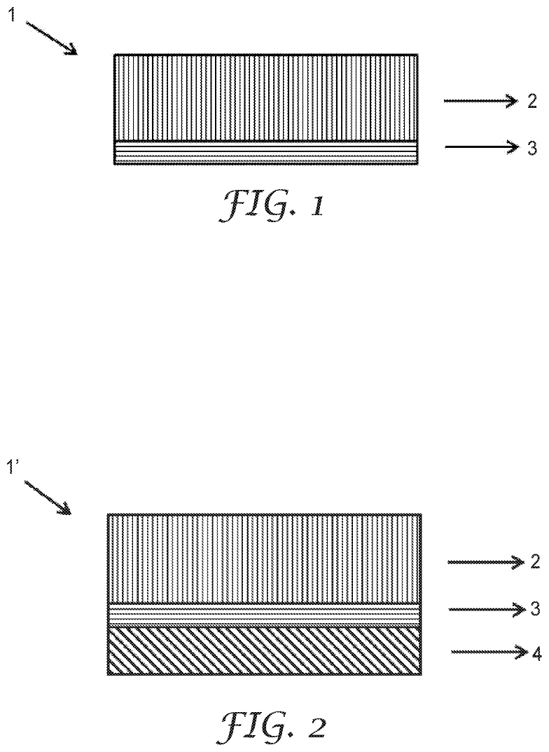

FIG. 1 shows a schematic cross-sectional view of a laminated sheet used to perform water filtration having a two-layer structure (a pre-filtration layer+a fine filtration layer) according to an embodiment of the present invention. As shown in FIG. 1, a laminated sheet 1 includes: a pre-filtration layer 2 and a fine filtration layer 3.

According to a preferred embodiment of the present invention, a laminated sheet used to perform water filtration having a three-layer structure is provided. The laminated sheet further includes a support layer on a side of the fine filtration layer disposed away from the pre-filtration layer. The function of the support layer is to effectively support the pre-filtration layer/fine filtration layer composite structure.

According to some preferred embodiments of the present invention, the support layer includes a fourth fiber. The fourth fiber has a diameter within a range of 2-50 μm, preferably within a range of 10-40 μm. No particular limitation is set to the diameter of pores in the support layer as long as the support layer does not affect effective passage of water having permeated through the pre-filtration layer and the fine filtration layer. Preferably, the support layer has a pore diameter within a range of 1-80 μm. Preferably, the pore diameter of the support layer is greater than the pore diameter of the pre-filtration layer. Preferably, the support layer has a thickness within a range of 0.05-1 mm. Preferably, the support layer has a grammage within a range of 60-300 g/m².

No particular limitation is set to the specific material of the fourth fiber that can be used in the present invention, and the material can be appropriately selected from fibrous materials commonly used as filtration materials in the art. Preferably, the material of the fourth fiber is selected from polyolefin, polyether, polyamide, polysulfone, polyester, fluoropolymer, polyacrylonitrile, polyurethane, polyvinyl alcohol, cellulose acetate, and a mixture or copolymer thereof. Specifically, the fourth fiber is selected from polyolefin fiber (for example, polyethylene fiber, polypropylene fiber, polystyrene fiber, etc.), polyether fiber (polyphenylene sulfide fiber, polyethylene oxide fiber, etc.), polyamide fiber (nylon 6 fiber, nylon 66 fiber, polyimide fiber, etc.), polysulfone fiber (polyethersulfone fiber, etc.), polyester fiber (polyethylene terephthalate fiber, polybutylene terephthalate fiber, etc.), fluoropolymer fiber (polyvinylidene fluoride fiber, polytetrafluoroethylene fiber, vinylidene fluoride-hexafluoropropylene copolymer fiber), polyacrylonitrile fiber, polyurethane fiber, polyvinyl alcohol fiber, etc.

Preferably, the fourth fiber is a hydrophilic fiber.

According to the technical solution of the present invention, the fine filtration layer and the support layer in the laminated sheet used to perform water filtration contact and fit to each other. No particular limitation is set to the specific type of a process for joining the fine filtration layer to the support layer as long as the joining process does not result in that an isolation structure hindering water permeation is formed between the fine filtration layer and the support layer. Preferably, the fine filtration layer and the support layer are joined by means of one of or a combination of the following processes: hot calendering, ultrasonic welding, and bonding. Preferably, the fine filtration layer and the support layer are joined by means of a hot calendering process.

FIG. 2 shows a schematic cross-sectional view of a laminated sheet used to perform water filtration having a three-layer structure (a pre-filtration layer+a fine filtration layer+a support layer) according to another embodiment of the present invention. As shown in FIG. 2, a laminated sheet 1′ includes: a pre-filtration layer 2, a fine filtration layer 3, and a support layer 4.

According to another aspect of the present invention, a filter element used to perform water filtration is provided. The filter element can be configured to be in a filtration apparatus in various commercially available water filters. Specifically, the filter element is formed by rolling the above laminated sheet into a shape of a cylinder. Preferably, in the cylindrical filter element, the pre-filtration layer is located on a water inlet side of the filter element. The fine filtration layer is immediately adjacent to the pre-filtration layer. The support layer is located on a water outlet side of the filter element. With respect of the specific structure of the filter element, the pre-filtration layer is located on an outer side of the cylinder. The fine filtration layer is immediately adjacent to the pre-filtration layer. The support layer is located on an inner side of the cylinder. In order to further improve a filtration effect of the filter element, a wall of the cylinder is preferably configured to be collapsible, equivalent to configuring the pre-filtration layer, the fine filtration layer, and the support layer to be collapsible. No particular limitation is set to a shape, an angle, and a density of the collapsible structure as long as the filter element can maintain good mechanical properties and achieve a good filtration effect. It should be noted that in order to maintain the mechanical properties of the filter element, the laminated sheet forming the filter element needs to include a support layer.

FIG. 3 shows a schematic cross-sectional view of a cylindrical filter element having a collapsible structure according to still another embodiment of the present invention. Specifically, the left drawing in FIG. 3 shows a cylindrical filter element having a collapsible structure. The pre-filtration layer is located on the outermost side of the cylinder. The fine filtration layer is adjacent to the pre-filtration layer. The support layer is adjacent to the aforementioned two filtration layers, and is located on an inner side of the cylinder. The right drawing in FIG. 3 shows a part of the collapsible structure of the cylindrical filter element.

No particular limitation is set to a method for manufacturing the above cylindrical filter element having a collapsible structure. A person skilled in the art can select a conventional process to roll the above laminated sheet into a shape of a cylinder so as to form the cylindrical filter element.

According to still another aspect of the present invention, a cylindrical filter element used to perform water filtration is provided. The filter element can be configured to be in a filtration apparatus in various commercially available water filters. Specifically, the cylindrical filter element, sequentially from the inside to the outside, includes:
a cylindrical inner core;
a cylindrical intermediate core, the cylindrical intermediate core being formed by rolling the above laminated sheet, wherein: when the support layer is present, the pre-filtration layer is located on an outer side of the cylindrical intermediate core, and the support layer is located on an inner side of the cylindrical intermediate core; or, when the support layer is absent, the pre-filtration layer is located on the outer side of the cylindrical intermediate core, and the fine filtration layer is located on the inner side of the cylindrical intermediate core; and
a cylindrical outer core.

Preferably, in the cylindrical filter element, the cylindrical inner core, the cylindrical intermediate core, and the cylindrical outer core contact each other. Preferably, a ratio of the thickness of the cylindrical inner core to the thickness of the cylindrical outer core is within a range of 0.5:1 to 2:1. In order to allow the filter element to achieve a better effect, the thickness of the cylindrical inner core is less than the thickness of the cylindrical outer core. More preferably, the ratio of the thickness of the cylindrical inner core to the thickness of the cylindrical outer core is within a range of 0.5:1 to less than 1:1.

No particular limitation is set to materials of the cylindrical inner core and the cylindrical outer core. A person skilled in the art can make a selection from conventional filtration materials used to perform water filtration. Preferably, the cylindrical inner core and the cylindrical outer core are prepared from materials respectively and independently selected from polyolefin, polyether, polyamide, polysulfone, polyester, fluoropolymer, polyacrylonitrile, polyurethane, polyvinyl alcohol, cellulose acetate, and a mixture or copolymer thereof. Specifically, the cylindrical inner core and the cylindrical outer core are prepared from materials respectively and independently selected from polyolefin fiber (for example, polyethylene fiber, polypropylene fiber, polystyrene fiber, etc.), polyether fiber (polyphenylene sulfide fiber, polyethylene oxide fiber, etc.), polyamide fiber (nylon 6 fiber, nylon 66 fiber, polyimide fiber, etc.), polysulfone fiber (polyethersulfone fiber, etc.), polyester fiber (polyethylene terephthalate fiber, polybutylene terephthalate fiber, etc.), fluoropolymer fiber (polyvinylidene fluoride fiber, polytetrafluoroethylene fiber, vinylidene fluoride-hexafluoropropylene copolymer fiber), polyacrylonitrile fiber, polyurethane fiber, polyvinyl alcohol fiber, etc.

The material of the cylindrical inner core and the material of the cylindrical outer core can be identical or different from each other.

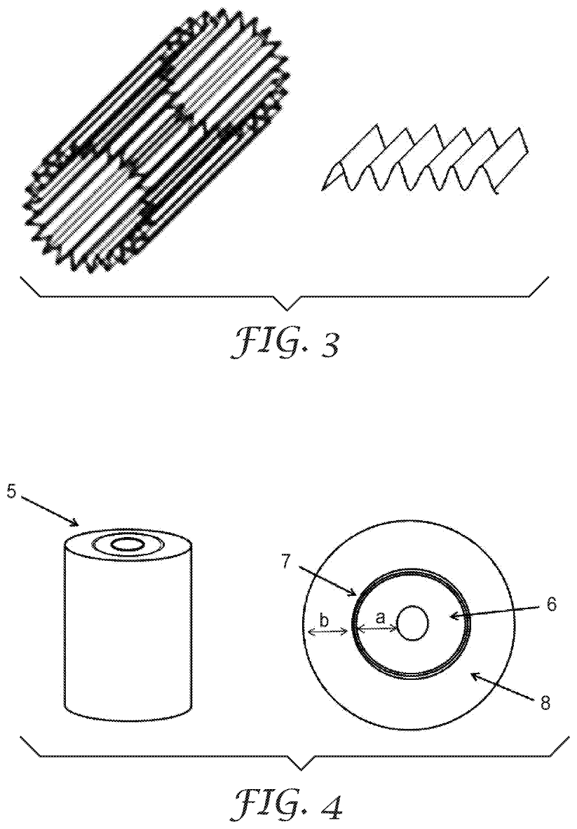

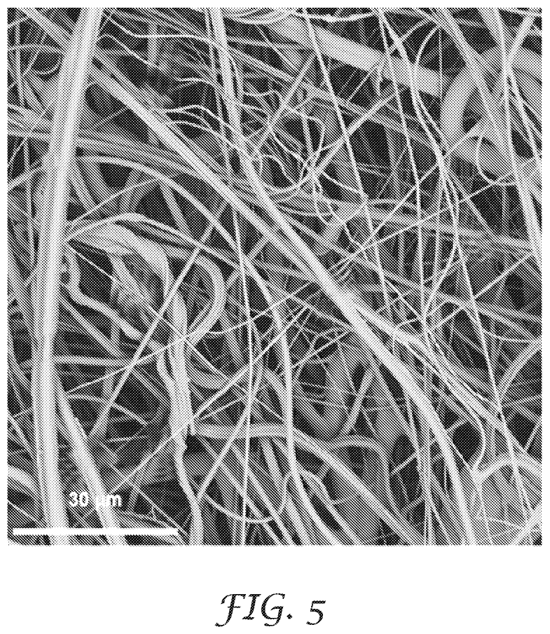

FIG. 4 shows a schematic cross-sectional view of a cylindrical filter element having an intercalation structure according to yet another embodiment of the present invention. Specifically, the left drawing in FIG. 4 shows a cylindrical filter element 5 having an intercalation structure. The right drawing in FIG. 4 shows a schematic cross-sectional view of the cylindrical filter element 5. The cylindrical filter element 5, sequentially from the inside to the outside, includes: a cylindrical inner core 6, a cylindrical intermediate core 7, and a cylindrical outer core 8. In the cylindrical filter element 5, the cylindrical inner core 6, the cylindrical intermediate core 7, and the cylindrical outer core 8 contact each other, and the thickness of the cylindrical inner core 6 is less than the thickness of the cylindrical outer core 8.

No particular limitation is set to a method for manufacturing the above cylindrical filter element having an intercalation structure. A person skilled in the art can reasonably select a conventional manufacturing method. For example, the sheet forming the cylindrical inner core, the laminated sheet according to the present invention, and the sheet forming the cylindrical outer core can be stacked and joined by a calender by means of hot calendering, and then a conventional process is selected to roll the acquired three-layer composite sheet into a shape of a cylinder.

According to yet another aspect of the present invention, a filtration kit used to perform water filtration is provided. The filtration kit accommodates the above cylindrical filter element used to perform water filtration. No particular limitation is set to the specific type of the filtration kit. The filtration kit can be a filter in the art commonly used to perform water filtration.

Various exemplary embodiments of the present invention are further described by a list of embodiments below, which should not be construed as unduly limiting the present invention:

Specific embodiment 1 is a laminated sheet used to perform water filtration. The laminated sheet includes:
a pre-filtration layer, wherein the pre-filtration layer includes a first fiber having a diameter within a range of 1-5 μm and a second fiber having a diameter within a range of 200-900 nm, and the pre-filtration layer has a pore diameter within a range of 0.2-1 μm; and
a fine filtration layer, the fine filtration layer having a pore diameter within a range of 0.02-0.5 μm, wherein
the pore diameter of the pre-filtration layer is greater than the pore diameter of the fine filtration layer.

Specific embodiment 2 is the laminated sheet used to perform water filtration according to specific embodiment 1, wherein the pre-filtration layer has a porosity within a range of 30-90%, and the fine filtration layer has a porosity within a range of 50-95%.

Specific embodiment 3 is the laminated sheet used to perform water filtration according to specific embodiment 1, wherein with the total weight of the pre-filtration layer being 100 wt %, the first fiber accounts for 50-99 wt %, and the second fiber accounts for 1-50 wt %.

Specific embodiment 4 is the laminated sheet used to perform water filtration according to specific embodiment 1, wherein the pre-filtration layer has a thickness within a range of 100-5000 μm.

Specific embodiment 5 is the laminated sheet used to perform water filtration according to specific embodiment 1, wherein the pre-filtration layer has a grammage within a range of 10-120 g/m².

Specific embodiment 6 is the laminated sheet used to perform water filtration according to specific embodiment 1, wherein the pre-filtration layer is prepared by means of one of or a combination of the following processes: melt blowing, carding, air laying, wet laying, and electrostatic spinning.

Specific embodiment 7 is the laminated sheet used to perform water filtration according to specific embodiment 1, wherein the fine filtration layer includes a third fiber having a diameter within a range of 10-200 nm.

Specific embodiment 8 is the laminated sheet used to perform water filtration according to specific embodiment 1, wherein the fine filtration layer has a thickness within a range of 5-50 μm.

Specific embodiment 9 is the laminated sheet used to perform water filtration according to specific embodiment 1, wherein the fine filtration layer has a grammage within a range of 0.5-5 g/m².

Specific embodiment 10 is the laminated sheet used to perform water filtration according to specific embodiment 1, wherein the pre-filtration layer and the fine filtration layer are joined by means of one of or a combination of the following processes: hot calendering, ultrasonic welding, and bonding.

Specific embodiment 11 is the laminated sheet used to perform water filtration according to specific embodiment 7, wherein the laminated sheet further includes a support layer on a side of the fine filtration layer disposed away from the pre-filtration layer.

Specific embodiment 12 is the laminated sheet used to perform water filtration according to specific embodiment 11, wherein the support layer includes a fourth fiber having a diameter within a range of 2-50 μm.

Specific embodiment 13 is the laminated sheet used to perform water filtration according to specific embodiment 11, wherein the support layer has a diameter within a range of 1-80 μm, and the pore diameter of the support layer is greater than the pore diameter of the pre-filtration layer.

Specific embodiment 14 is the laminated sheet used to perform water filtration according to specific embodiment 12, wherein the first fiber, the second fiber, the third fiber, and the fourth fiber are prepared from material respectively and independently selected from polyolefin, polyether, polyamide, polysulfone, polyester, fluoropolymer, polyacrylonitrile, polyurethane, polyvinyl alcohol, cellulose acetate, and a mixture or copolymer thereof.

Specific embodiment 15 is a filter element used to perform water filtration, the filter element being formed by rolling the laminated sheet according to any one of preceding specific embodiments 11-14 into a shape of a cylinder, wherein the pre-filtration layer is located on an outer side of the cylinder, and the support layer is located on an inner side of the cylinder.

Specific embodiment 16 is the filter element used to perform water filtration according to specific embodiment 15, wherein a wall of the cylinder is configured to be collapsible.

Specific embodiment 17 is a cylindrical filter element used to perform water filtration, the cylindrical filter element, sequentially from the inside to the outside, including:
a cylindrical inner core;
a cylindrical intermediate core, the cylindrical intermediate core being formed by rolling the laminated sheet according to any one of preceding specific embodiments 1-14, wherein: when the support layer is present, the pre-filtration layer is located on an outer side of the cylindrical intermediate core, and the support layer is located on an inner side of the cylindrical intermediate core; or, when the support layer is absent, the pre-filtration layer is located on the outer side of the cylindrical intermediate core, and the fine filtration layer is located on the inner side of the cylindrical intermediate core; and
a cylindrical outer core.

Specific embodiment 18 is a cylindrical filter element used to perform water filtration according to specific embodiment 17, wherein the cylindrical inner core, the cylindrical intermediate core, and the cylindrical outer core contact each other.

Specific embodiment 19 is a filtration kit used to perform water filtration, wherein the filtration kit accommodates the cylindrical filter element used to perform water filtration according to specific embodiments 17 or 18.

The present invention will be described below in more details in combination with embodiments. It needs to be pointed out that these descriptions and embodiments are all intended to make the invention easy to understand, rather than to limit the invention. The protection scope of the present invention is subject to the appended claims.

### EMBODIMENTS

Unless otherwise indicated, all of materials used in the present invention are commercially available products, and are used directly without being further purified.

In the embodiments of the present invention and the comparative examples, a series of filtration sheets were prepared, and the performance thereof such as a pressure difference and filtration efficiency was studied according to the following test method.

### Test Method

### Particle Removal Efficiency (%)

Firstly, kaolin (KaMin HG90, KaMin Company) with a particle size within a range of 0.2 to 0.4 μm was dispersed in pure water at a concentration of about 0.5 mg/L to acquire a test dispersion liquid. Then, the test dispersion liquid was caused to flow through a particle counter (Ultrapure 100, HACH), and the particle counter provided a particle concentration in the dispersion liquid, the particle concentration being denoted as P0. The particle concentration was measured in units of the number of particles per milliliter (pcs/ml). The particle counter can acquire, by means of analysis according to a particle size, the number of particles of the corresponding size in a liquid. Four units of measurement are configured for the particle size: 0.1 μm, 0.2 μm, 0.5 μm, and 1.0 μm. That is, the particle counter can measure the number of particles with a particle size greater than 0.1 μm, the number of particles with a particle size greater than 0.2 μm, the number of particles with a particle size greater than 0.5 μm, and the number of particles with a particle size greater than 1 μm. During testing of filtration performance of a filtration medium, filtration media from the embodiments and the comparative examples described below were cut into circular sheets with a diameter of 47 mm, or were made into standard 10-inch filter elements. The circular sheet or the filter element was placed in a corresponding closed filtration apparatus, and the above 0.5 mg/L kaolin dispersion liquid was pumped through the filtration medium (filter element) at a certain flow rate. Specifically, when the filtration medium was a circular sheet with a diameter of 47 mm, the flow rate was 100 ml/min, and when the filtration medium was a standard 10-inch filter element, the flow rate was 2 gallon/min. Then, the filtered liquid was fed into the particle counter at a flow rate of 100 ml/min, and the particle concentration in the filtrate was measured at 1 minute, 5 minutes, and 25 minutes. The measurements were respectively denoted as the particle concentration at 1 minute (P1), the particle concentration at 5 minutes (P5), and the particle concentration at 25 minutes (P25).

Initial particle removal efficiency PREᵢₙᵢₜᵢₐₗ (%), particle removal efficiency PRE₅ (%) at 5 minutes, and particle removal efficiency PRE₂₅ (%) at 25 minutes of the filtration sheet under test were calculated by means of the following formulas.

$${PRE}_{initial} = ( P 0 - P 1 ) / P 0 \times 100 \% \\ {PRE}_{5} = ( P 0 - P 5 ) / P 0 \times 100 \% \\ {PRE}_{25} = ( P 0 - P 25 ) / P 0 \times 100 \%$$

During testing of filtration efficiency of the filtration sheet for particles with a particle size less than 0.1 μm, gold nanoparticles with a certain particle diameter distribution (20-60 nm) were firstly dispersed in pure water, and a single particle inductively coupled plasma mass spectrometer (Single Particle ICP-MS, 7900, Agilent Company) was used to analyze the concentration of gold nanoparticles within a corresponding particle diameter range in the dispersion liquid. Then, a certain volume of the original gold nanoparticle dispersion liquid was filtered by the filtration sheet, and the filtered liquid was analyzed again by the single particle inductively coupled plasma mass spectrometer to acquire the concentration of gold nanoparticles within the corresponding particle diameter range in the liquid. The particle concentrations before and after filtration were plotted with the particle size (particle diameter) being the horizontal axis and with the particle concentration being the vertical axis to acquire the filtration efficiency of the filtration sheet for particles smaller than 0.1 μm.

### Turbidity Test

Firstly, kaolin (KaMin HG90, KaMin Company) with a particle size within a range of 0.2 to 0.4 μm was dispersed in pure water at a concentration of about 50 mg/L to acquire a test dispersion liquid. 47-mm circular filtration sheet samples acquired in the following embodiments or comparative examples were mounted on a filter holder of a filter. Then, the test dispersion liquid was pumped through the filter at a constant flow rate of 30 ml/min. Then, a turbidimeter (2100Q, HACH Company) was used to separately measure the turbidity of the dispersion liquid at an inlet of the filter and the turbidity of the dispersion liquid at an outlet of the filter. A piezometer was used to measure the pressure of the dispersion liquid at the inlet of the filter and the pressure of the dispersion liquid at the outlet of the filter so as to calculate a pressure difference. As soon as the pressure difference reached approximately 25 psi, the measurement ended.

Then, for each filtration sheet, a curve graph of the pressure difference (psi) and the turbidity removal efficiency (%; calculated from turbidity data) versus the cumulative volume of the filtered dispersion liquid was drawn, wherein the left vertical axis represented the pressure difference, and the right vertical axis represented the turbidity removal efficiency (%). The physical meaning of the cumulative volume is, under this test condition and when a pressure difference between two sides of a filter membrane per unit area reaches 25 psi, the total volume of a filtrate having undergone filtration, and the unit is L/m².

### Flow Rate-Pressure Difference Test

Circular sheets with a diameter of 47 mm acquired in the following embodiments or comparative examples were placed in corresponding fixtures, and a peristaltic pump was used to pump deionized water through the test filtration sheet at the following flow rates: 30 ml/min, 50 ml/min, 100 ml/min, 150 ml/min, 200 ml/min, 250 ml/min, and 300 ml/min. A differential pressure gauge was used to measure a pressure difference between two sides of a filter membrane at a corresponding flow rate, and then a flow rate-pressure difference curve was drawn.

### Porosity Test

The porosity of the pre-filtration layer and the porosity of the fine filtration layer used in the following embodiments 1-4 were tested. Specifically, the porosity was represented by the

$$Porosity ( P \% ) = ( 1 - {m}_{nw} / ρ \cdot H \cdot S ) \times 100 \%$$

where
m_{nw} was the mass (unit: g) of the pre-filtration layer or the fine filtration layer measured by an analytical balance;
ρ was the density (unit: g/cm³) of the pre-filtration layer or the fine filtration layer;
H was the thickness (unit: cm) of the pre-filtration layer or the fine filtration layer; and
S was the area (unit: cm²) of the pre-filtration layer or the fine filtration layer.

### Embodiment 1

A pre-filtration layer was prepared by using the following method: crystalline polypropylene resin (Liande Basel Company) and tackifier piperylene of a mass ratio of 9:1 were fed into an extruder, and the temperature of the extruder was controlled to be higher than the melting point of the polypropylene resin. The molten resin was then extruded into a melt blowing die. The melt passed through at least one group of spinneret orifices, and was then sprayed out, drawn by high-temperature high-speed gas, and collected in a negative-pressure roller, so that a mixed fiber assembly of polypropylene-based micron fiber (the first fiber) and polypropylene-based sub-micron fiber (the second fiber) was prepared. The mixed fiber assembly was subjected to preliminary fitting performed by means of a rubber roller at room temperature to form a web for subsequent use. The grammage of the assembly of the first fiber and the second fiber was 15 g/m², and the morphology thereof captured by a scanning electron microscope is shown in FIG. 5. As shown in FIG. 5, the typical diameter of the first fiber was 2.16 μm to 4.26 μm, and the typical diameter of the second fiber was 347 nm to 873 nm. The pre-filtration layer has a pore diameter of 0.8 μm measured according to an ASTM E1294-89 test method, and has a porosity of about 80%.

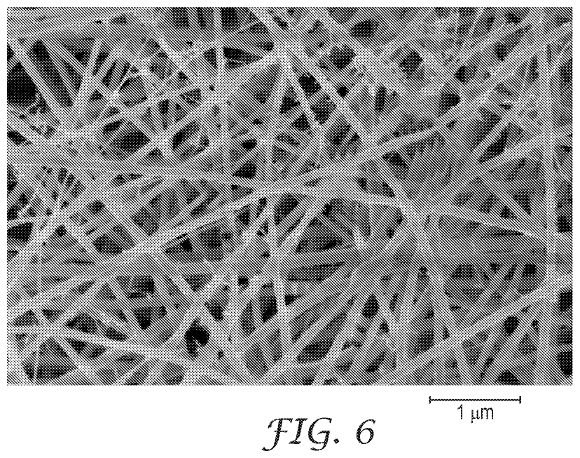

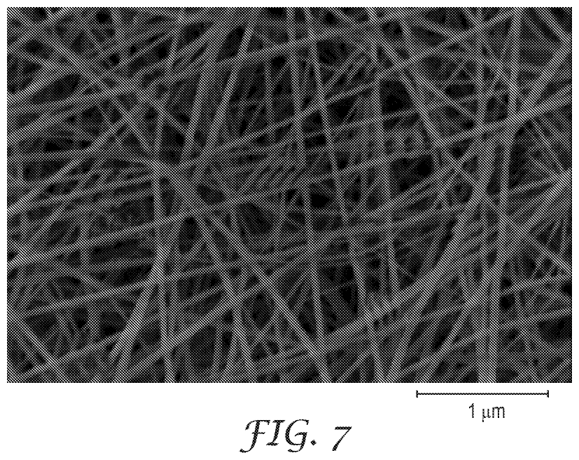

A fine filtration layer was prepared by using the following method: nylon 6 resin (PA6, Ultramid®, BASF Company) was dissolved in a formic acid/acetic acid mixed solution with a volume ratio of 7:3, and a solid content of the PA6 solution was controlled to be a concentration of 11 wt %. The PA6 solution was placed in a needleless electrostatic spinning machine. A spinning voltage was controlled to be 80 kV, and the distance between a spinning electrode and a receiving electrode was controlled to be about 17 cm. The grammage of an acquired PA6 nanofiber (the third fiber) non-woven fabric was about 1.4 g/m². The diameter of the PA6 nanofiber was about 100 nm, and the morphology thereof captured by the scanning electron microscope is shown in FIG. 6. A pore diameter of about 0.15 μm was measured according to the ASTM E1294-89 test method, and a porosity of about 75% was measured.

Then, the above pre-filtration sheet and fine filtration layer (namely, the electrospun nylon fiber fine filtration layer prepared above) were joined by means of calendering performed by using a hot roll calender, so as to acquire a filtration sheet. The temperature of a calender roll of the calender was 215 degrees Fahrenheit. Calendering pressure was 0.4 MPa. A linear speed was 1 m/min. In the acquired laminated filtration sheet, the thickness of the pre-filtration layer was 180 μm, and the thickness of the fine filtration layer was 20 μm. After the calendering process was completed, the filter membrane was cut into a circular sheet with a diameter of 47 mm. The thickness of the circular sheet was about 200 μm. Then, the aforementioned particle removal efficiency (%) test method and turbidity test method were used to test performance such as a pressure difference, filtration efficiency, etc. of the acquired filtration sheet.

### Embodiment 2

A pre-filtration layer was prepared by using the following method: crystalline polypropylene resin (Liande Basel Company) and tackifier piperylene of a mass ratio of 9:1 were fed into an extruder, and the temperature of the extruder was controlled to be higher than the melting point of the polypropylene resin. The molten resin was then extruded into a melt blowing die. The melt passed through at least one group of spinneret orifices, and was then sprayed out, drawn by high-temperature high-speed gas, and collected in a negative-pressure roller, so that a mixed fiber assembly of polypropylene-based micron fiber (the first fiber) and polypropylene-based sub-micron fiber (the second fiber) was prepared. The mixed fiber assembly was subjected to preliminary fitting performed by means of a rubber roller at room temperature to form a web for subsequent use. The grammage of the assembly of the first fiber and the second fiber was 15 g/m², and the morphology thereof captured by a scanning electron microscope is shown in FIG. 5. As shown in FIG. 5, the typical diameter of the first fiber was 2.16 μm to 4.26 μm, and the typical diameter of the second fiber was 347 nm to 873 nm. The pre-filtration layer has a pore diameter of 0.8 μm measured according to an ASTM E1294-89 test method, and has a porosity of about 80%.

A fine filtration layer was prepared by using the following method: nylon 6 resin (PA6, Ultramid R, BASF Company) was dissolved in a formic acid/acetic acid mixed solution with a volume ratio of 7:3, and a solid content of the PA6 solution was controlled to be a concentration of 11 wt %. The PA6 solution was placed in a needleless electrostatic spinning machine. A spinning voltage was controlled to be 80 kV, and the distance between a spinning electrode and a receiving electrode was controlled to be about 17 cm. The grammage of an acquired PA6 nanofiber (the third fiber) non-woven fabric was about 1.4 g/m². The diameter of the PA6 nanofiber was about 100 nm, and the morphology thereof captured by the scanning electron microscope is shown in FIG. 6. A pore diameter of about 0.15 μm was measured according to the ASTM E1294-89 test method, and a porosity of about 75% was measured.

A support layer Typar was polypropylene fiber manufactured by means of a spunbonding process. The diameter of the fiber was about 50 μm. The fiber was directly purchased from PGI Company, and the brand name thereof is Tekton 3161L.

Then, the above pre-filtration layer, fine filtration layer, and support layer were joined by means of calendering performed by using a hot roll calender, so as to acquire a filtration sheet. The temperature of a calender roll of the calender was 215 degrees Fahrenheit. Calendering pressure was 0.4 MPa. A linear speed was 1 m/min. The total thickness of the laminated filtration sheet acquired by means of calendering was about 350 μm. The thickness of the pre-filtration layer was 180 μm. The thickness of the fine filtration layer was 20 μm. The thickness of the support layer was 150 μm.

The above filtration sheet was made into a 10-inch filter element by means of a striking and bending process. Then, the aforementioned particle removal efficiency (%) test method and turbidity test method were used to test performance such as a pressure difference, filtration efficiency, etc. of the acquired filter element.

### Embodiment 3

A pre-filtration layer was prepared by using the following method: crystalline polypropylene resin (Liande Basel Company) and tackifier piperylene of a mass ratio of 9:1 were fed into an extruder, and the temperature of the extruder was controlled to be higher than the melting point of the polypropylene resin. The molten resin was then extruded into a melt blowing die. The melt passed through at least one group of spinneret orifices, and was then sprayed out, drawn by high-temperature high-speed gas, and collected in a negative-pressure roller, so that a mixed fiber assembly of polypropylene-based micron fiber (the first fiber) and polypropylene-based sub-micron fiber (the second fiber) was prepared. The mixed fiber assembly was subjected to preliminary fitting performed by means of a rubber roller at room temperature to form a web for subsequent use. The grammage of the assembly of the first fiber and the second fiber was 45 g/m², and the morphology thereof captured by a scanning electron microscope is shown in FIG. 5. As shown in FIG. 5, the typical diameter of the first fiber was 2.16 μm to 4.26 μm, and the typical diameter of the second fiber was 347 nm to 873 nm. The pre-filtration layer has a pore diameter of 0.8 μm measured according to an ASTM E1294-89 test method, and has a porosity of about 80%.

A fine filtration layer was prepared by using the following method: nylon 6 resin (PA6, Ultramid R, BASF Company) was dissolved in a formic acid/acetic acid mixed solution with a volume ratio of 7:3, and a solid content of the PA6 solution was controlled to be a concentration of 11 wt %. The PA6 solution was placed in a needleless electrostatic spinning machine. A spinning voltage was controlled to be 80 kV, and the distance between a spinning electrode and a receiving electrode was controlled to be about 17 cm. The grammage of an acquired PA6 nanofiber (the third fiber) non-woven fabric was about 1.4 g/m². The diameter of the PA6 nanofiber was about 100 nm, and the morphology thereof captured by the scanning electron microscope is shown in FIG. 6. A pore diameter of about 0.15 μm was measured according to the ASTM E1294-89 test method, and a porosity of about 75% was measured.

Then, the above pre-filtration layer and fine filtration layer were joined by means of calendering performed by using a hot roll calender, so as to acquire a filtration sheet. The temperature of a calender roll of the calender was 215 degrees Fahrenheit. Calendering pressure was 0.4 MPa. A linear speed was 1 m/min. In the acquired laminated filtration sheet, the thickness of the pre-filtration layer was 580 μm, and the thickness of the fine filtration layer was 20 μm. After the calendering process was completed, the filtration sheet was cut into a circular sheet with a diameter of 47 mm. The total thickness of the laminated filtration sheet was about 600 μm. Then, the aforementioned particle removal efficiency (%) test method and turbidity test method were used to test performance such as a pressure difference, filtration efficiency, etc. of the acquired filtration sheet.

### Embodiment 4

A pre-filtration layer was prepared by using the following method: crystalline polypropylene resin (Liande Basel Company) and tackifier piperylene of a mass ratio of 9:1 were fed into an extruder, and the temperature of the extruder was controlled to be higher than the melting point of the polypropylene resin. The molten resin was then extruded into a melt blowing die. The melt passed through at least one group of spinneret orifices, and was then sprayed out, drawn by high-temperature high-speed gas, and collected in a negative-pressure roller, so that a mixed fiber assembly of polypropylene-based micron fiber (the first fiber) and polypropylene-based sub-micron fiber (the second fiber) was prepared. The mixed fiber assembly was subjected to preliminary fitting performed by means of a rubber roller at room temperature to form a web for subsequent use. The grammage of the assembly of the first fiber and the second fiber was 15 g/m², and the morphology thereof captured by a scanning electron microscope is shown in FIG. 5. As shown in FIG. 5, the typical diameter of the first fiber was 2.16 μm to 4.26 μm, and the typical diameter of the second fiber was 347 nm to 873 nm. The pre-filtration layer has a pored diameter of 0.8 μm measured according to an ASTM E1294-89 test method, and has a porosity of about 80%.

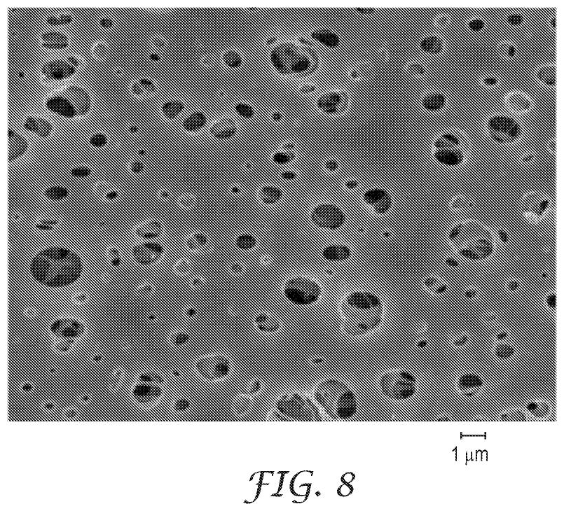

A fine filtration layer was prepared by using the following method: nylon 6 resin (PA6, Ultramid®, BASF Company) was dissolved in formic acid, and a solid content of the PA6 solution was controlled to be a concentration of 8 wt %. The PA6 solution was placed in a needleless electrostatic spinning machine. A spinning voltage was controlled to be 120 kV, and the distance between a spinning electrode and a receiving electrode was controlled to be about 17 cm. The grammage of an acquired PA6 nanofiber (the third fiber) non-woven fabric was about 1.4 g/m². The diameter of the PA6 nanofiber was about 30-80 nm, and the morphology thereof captured by the scanning electron microscope is shown in FIG. 7. A pore diameter of about 0.10 μm was measured according to the ASTM E1294-89 test method, and a porosity of about 87% was measured.

Then, the above pre-filtration layer and fine filtration layer were joined by means of calendering performed by using a hot roll calender, so as to acquire a filtration sheet. The temperature of a calender roll of the calender was 215 degrees Fahrenheit. Calendering pressure was 0.4 MPa. A linear speed was 1 m/min. In the acquired laminated filtration sheet, the thickness of the pre-filtration layer was 180 μm, and the thickness of the fine filtration layer was 15 μm. After the calendering process was completed, the filtration sheet was cut into a circular sheet with a diameter of 47 mm. The thickness of the circular sheet was about 195 μm. Then, the aforementioned particle removal efficiency (%) test method and turbidity test method were used to test performance such as a pressure difference, filtration efficiency, etc. of the acquired filtration sheet.

In order to facilitate comparison, specific data regarding the pre-filtration layer, the fine filtration layer, and the support layer in the above embodiments 1-4 is shown in Table 1 below.

TABLE 1
Specific data regarding the pre-filtration layer, the fine
filtration layer, and the support layer in embodiments 1-4

| | | Embodiment | Embodiment | Embodiment | Embodiment |
|---|---|---|---|---|---|
| | Data | 1 | 2 | 3 | 4 |
| Pre- | Diameter of first fiber | 2.16-4.26 | 2.16-4.26 | 2.16-4.26 | 2.16-4.26 |
| filtration | (μm) | | | | |
| layer | Diameter of second | 347-873 | 347-873 | 347-873 | 347-873 |
| | fiber (nm) | | | | |
| | Pore diameter (μm) | 0.8 | 0.8 | 0.8 | 0.8 |
| | Porosity (%) | 80 | 80 | 80 | 80 |
| | Thickness (μm) | 180 | 180 | 580 | 180 |
| | Grammage (g/m²) | 15 | 15 | 45 | 15 |
| Fine | Diameter of third fiber | 100 | 100 | 100 | 30-80 |
| filtration | (nm) | | | | |
| layer | Pore diameter (μm) | 0.15 | 0.15 | 0.15 | 0.1 |
| | Porosity (%) | 75 | 75 | 75 | 87 |
| | Thickness (μm) | 20 | 20 | 20 | 15 |
| | Grammage (g/m²) | 1.4 | 1.4 | 1.4 | 1.4 |
| Support | Fourth fiber (μm) | | 50 | | |
| layer | Thickness (μm) | | 150 | | |

### COMPARATIVE EXAMPLE 1

A multi-layer hot-pressed polypropylene non-woven filtration material prepared by means of a melt blowing process was used as a pre-filtration layer. A nominal filtration level of the pre-filtration layer was 2.5 μm. The pre-filtration layer has removal efficiency greater than 99% for particles larger than 2.5 μm. The filtration sheet was a multi-layer blown polypropylene non-woven fabric of which layers were joined by means of hot calendering, and consisted of polypropylene fiber with a diameter of 1-5 μm. The thickness of the filtration sheet was about 200 μm.

Then, the above pre-filtration layer and the fine filtration layer prepared in embodiment 1 were joined by means of calendering performed by using a hot roll calender so as to acquire a filtration sheet. The temperature of a calender roll of the calender was 215 degrees Fahrenheit. Calendering pressure was 0.4 MPa. A linear speed was 1 m/min. In the acquired laminated filtration sheet, the thickness of the pre-filtration layer was 200 μm, and the thickness of the fine filtration layer was 20 μm. After the calendering process was completed, the filtration sheet was cut into a circular sheet with a diameter of 47 mm. The thickness of the circular sheet was about 220 μm. Then, the aforementioned particle removal efficiency (%) test method and turbidity test method were used to test performance such as a pressure difference, filtration efficiency, etc. of the acquired filtration sheet.

### COMPARATIVE EXAMPLE 2

A multi-layer hot-pressed polypropylene non-woven filtration material prepared by means of a melt blowing process was used as a filtration material. A nominal filtration level of the filtration material was 0.2 μm. The filtration material has removal efficiency greater than 99% for particles larger than 0.2 μm. The filtration sheet was a multi-layer blown polypropylene non-woven fabric of which layers were joined by means of hot calendering, and consisted of polypropylene fiber with a diameter of 1-5 μm. After the calendering process was completed, the filtration sheet was cut into a circular sheet with a diameter of 47 mm. The thickness of the circular sheet was 350 μm. Then, the aforementioned particle removal efficiency (%) test method and turbidity test method were used to test performance such as a pressure difference, filtration efficiency, etc. of the acquired filtration sheet.

### COMPARATIVE EXAMPLE 3

A PES filter membrane with a filtration level of 0.2 μm was used as a filtration material. The filtration material has removal efficiency greater than 99% for particles larger than 0.2 μm. The filter membrane was prepared by means of a phase separation process. Through filtration pores existed between an upper surface and a lower surface of the filter membrane, and the structure thereof captured by a scanning electron microscope is shown in FIG. 8. The filter membrane was cut into a circular sheet with a diameter of 47 mm. The thickness of the circular sheet was 200 μm. Then, the aforementioned particle removal efficiency (%) test method and turbidity test method were used to test performance such as a pressure difference, filtration efficiency, etc. of an acquired filter element.

TABLE 2

| | |
|---|---|
| Particle | Embodiment 1 |

| size (μm) | 0.1 | 0.2 | 0.5 | 1.0 |
|---|---|---|---|---|
| PREᵢₙᵢₜᵢₐₗ (%) | 99.61 | 99.99 | 99.99 | 99.99 |
| PRE₅ (%) | 99.76 | 99.99 | 99.99 | 99.99 |
| PRE₂₅ (%) | 99.80 | 99.99 | 99.99 | 99.99 |

TABLE 3

| | |
|---|---|
| Particle | Embodiment 2 |

| size (μm) | 0.1 | 0.2 | 0.5 | 1.0 |
|---|---|---|---|---|
| PREᵢₙᵢₜᵢₐₗ (%) | 92.76 | 99.26 | 99.77 | 99.04 |
| PRE₅ (%) | 97.24 | 99.69 | 99.94 | 99.99 |
| PRE₂₅ (%) | 97.91 | 99.78 | 99.99 | 99.99 |

TABLE 4

| | |
|---|---|
| Particle | Embodiment 3 |

| size (μm) | 0.1 | 0.2 | 0.5 | 1.0 |
|---|---|---|---|---|
| PREᵢₙᵢₜᵢₐₗ (%) | 94.63 | 99.12 | 99.66 | 99.99 |
| PRE₅ (%) | 95.91 | 99.44 | 99.87 | 99.99 |
| PRE₂₅ (%) | 98.48 | 99.83 | 99.99 | 99.99 |

TABLE 5

| | |
|---|---|
| Particle | Embodiment 4 |

| size (μm) | 0.1 | 0.2 | 0.5 | 1.0 |
|---|---|---|---|---|
| PREᵢₙᵢₜᵢₐₗ (%) | 99.99 | 99.99 | 99.99 | 99.99 |
| PRE₅ (%) | 99.99 | 99.99 | 99.99 | 99.99 |
| PRE₂₅ (%) | 99.99 | 99.99 | 99.99 | 99.99 |

TABLE 6

| | |
|---|---|
| Particle | Comparative Example 1 |

| size (μm) | 0.1 | 0.2 | 0.5 | 1.0 |
|---|---|---|---|---|
| PREᵢₙᵢₜᵢₐₗ (%) | 90.23 | 98.20 | 99.10 | 99.04 |
| PRE₅ (%) | 92.77 | 99.69 | 99.92 | 99.99 |
| PRE₂₅ (%) | 97.25 | 99.81 | 99.94 | 99.99 |

TABLE 7

| | |
|---|---|
| Particle | Comparative Example 2 |

| size (μm) | 0.1 | 0.2 | 0.5 | 1.0 |
|---|---|---|---|---|
| PREᵢₙᵢₜᵢₐₗ (%) | 0 | 44.12 | 99.96 | 99.99 |
| PRE₅ (%) | 45.66 | 63.61 | 99.96 | 99.99 |
| PRE₂₅ (%) | 56.17 | 87.23 | 99.99 | 99.99 |

TABLE 8

| | |
|---|---|
| Particle | Comparative Example 3 |

| size (μm) | 0.1 | 0.2 | 0.5 | 1.0 |
|---|---|---|---|---|
| PREᵢₙᵢₜᵢₐₗ (%) | 75.91 | 99.39 | 99.63 | 99.99 |
| PRE₅ (%) | 88.25 | 99.77 | 99.93 | 99.99 |
| PRE₂₅ (%) | 92.43 | 99.91 | 99.98 | 99.99 |

Tables 2-8 show results of particle removal efficiency tests performed on the filtration sheets and the filter elements in the above embodiments 1-4 and comparative examples 1-3 according to the particle removal efficiency test method described above.

As shown in Tables 2-8 above, since the laminated filtration sheets and the filter elements acquired in embodiments 1-4 and comparative example 1 include a fine filtration layer, the acquired filtration materials have relatively high filtration efficiency for fine particles such as 0.1-μm particles and 0.2-μm particles. Particularly, in an initial stage of filtration, all of the filtration sheets or the filter elements including a fine filtration layer can continuously and efficiently retain fine particles. The filtration efficiency for fine particles in the initial stage completely depends on the filtration performance of the filtration material, and additional filtration efficiency provided by a subsequently formed particle powder cake layer is not required. By comparing embodiments 1-4 with comparative example 2, it can be further learned that the fine filtration layer plays a significant role in effective filtration of fine particles. By comparing embodiment 1 with embodiment 4, it can be learned that the diameter of the third fiber in the fine filtration layer, the diameter of the pores in the fine filtration layer, and the porosity of the fine filtration layer have a substantial effect on the filtration efficiency for fine particles and especially on the filtration efficiency for particles of the 0.1-μm level. In embodiment 1, the third fiber with a diameter of 100 nm, a pore diameter of 0.15 μm, and a porosity of 75% has filtration efficiency of 99.61% for 0.1-μm particles in the initial stage, and if the value is converted into a logarithm based on 10, then a drop value is about 2.41. In embodiment 4, the third fiber with a diameter of 30-80 nm, a pore diameter of 0.1 μm, and a porosity of 87% has filtration efficiency of 99.99% for 0.1-μm particles in the initial stage, and if the value is converted into a logarithm based on 10, then a drop value is about 4. Although the thickness of the fine filtration layer in embodiment 1 is greater than the thickness of the fine filtration layer in embodiment 4, embodiment 4 has higher filtration efficiency for particles of the 0.1-μm level.

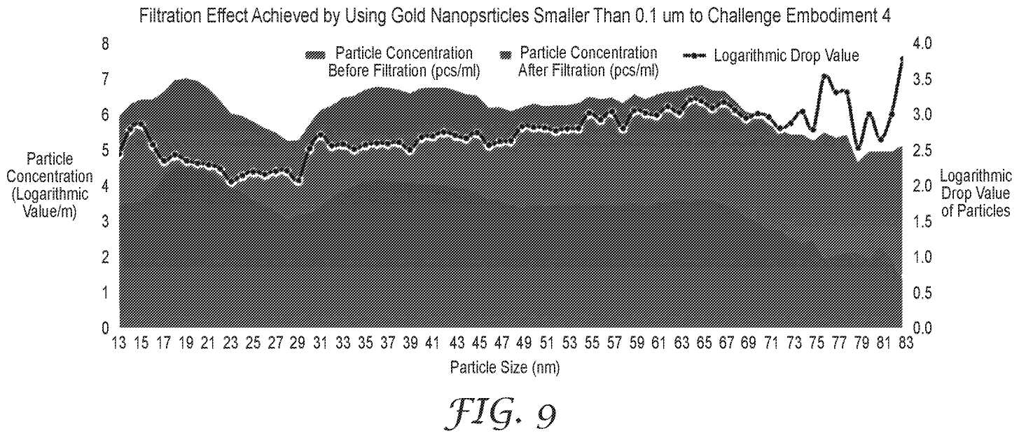

In order to further illustrate the effect of the diameter, the pore diameter, and the porosity of the fiber in the fine filtration layer on the filtration efficiency for particles, filtration efficiency of the laminated sheet prepared in embodiment 4 for gold nanoparticles smaller than 0.1 μm was tested, and a result thereof is shown in FIG. 9. Part 1 represents the concentrations (expressed in base-10 logarithmic values divided by ml) of gold nanoparticles of corresponding sizes in the dispersion liquid before filtration, and part 2 represents the concentrations (expressed in base-10 logarithmic values divided by ml) of gold nanoparticles of the corresponding sizes in the filtrate after being filtered by the laminated sheet prepared in embodiment 4. For example, gold nanoparticles having a particle size of 13 nm have a concentration of 5.92 before filtration. After filtration, the concentration of the gold nanoparticles having a particle size of 13 nm in the dispersion liquid decreases to 3.49. Thus, the gold nanoparticles having a particle size of 13 nm have a drop value of 2.43 after filtration. That is, the laminated sheet prepared in embodiment 4 has a filtration efficiency of (1−10^{-2.43})×100%=99.63% when used to filtrate gold nanoparticles having a particle size of 13 nm. Drop values obtained by measuring the concentrations of gold nanoparticles having various particle sizes before and after filtration are plotted into the curve in FIG. 9. Therefore, it can be learned that, when used to filtrate particles having a particle diameter of 13 nm to 83 nm, the laminated sheet prepared in embodiment 4 has an average drop value of about 2.70, equivalent to having a filtration efficiency of 99.8%.

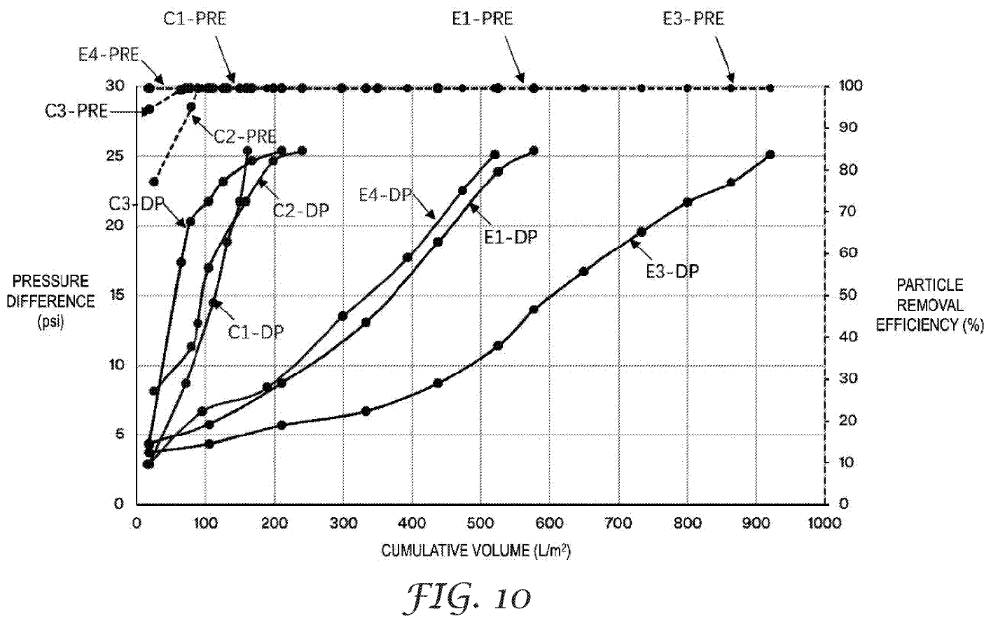

FIG. 10 shows turbidity test results of the filtration sheets in the embodiments and the comparative examples. In FIG. 10, E1-DP represents the curve formed by pressure difference values of the filtration sheet prepared according to embodiment 1 corresponding to different cumulative volumes; E3-DP represents the curve formed by pressure difference values of the filtration sheet prepared according to embodiment 3 corresponding to different cumulative volumes; E4-DP represents the curve formed by pressure difference values of the filtration sheet prepared according to embodiment 4 corresponding to different cumulative volumes; C1-DP represents the curve formed by pressure difference values of the filtration sheet prepared according to comparative example 1 corresponding to different cumulative volumes; C2-DP represents the curve formed by pressure difference values of the filtration sheet prepared according to comparative example 2 corresponding to different cumulative volumes; C3-DP represents the curve formed by pressure difference values of the filtration sheet prepared according to comparative example 3 corresponding to different cumulative volumes; E1-PRE represents the curve formed by turbidity removal efficiency values of the filtration sheet prepared according to embodiment 1 corresponding to different cumulative volumes; E3-PRE represents the curve formed by turbidity removal efficiency values of the filtration sheet prepared according to embodiment 3 corresponding to different cumulative volumes; E4-PRE represents the curve formed by turbidity removal efficiency values of the filtration sheet prepared according to embodiment 4 corresponding to different cumulative volumes; C1-PRE represents the curve formed by turbidity removal efficiency values of the filtration sheet prepared according to comparative example 1 corresponding to different cumulative volumes; C2-PRE represents the curve formed by turbidity removal efficiency values of the filtration sheet prepared according to comparative example 2 corresponding to different cumulative volumes; C3-PRE represents the curve formed by turbidity removal efficiency values of the filtration sheet prepared according to comparative example 3 corresponding to different cumulative volumes.

It can be learned from the result in FIG. 10 that during the test, the filtration sheet in embodiment 1 had relatively slow increases in the pressure difference, and maintained high filtration efficiency. When the pressure difference between two sides of the filtration sheet of embodiment 1 reached 25 psi, the filtration sheet per unit area produced a total amount of about 575 L of water. In addition, from the beginning of the test, the filtration sheet maintained the turbidity removal efficiency close to 100% until the end of the test. By comparison with embodiment 1, the grammage and the thickness of the pre-filtration layer in embodiment 3 are about 3 times those of the pre-filtration layer in embodiment 1. During the test, the filtration sheet had slowest increases in the pressure difference, and maintained high filtration efficiency. When the pressure difference between two sides of the filtration sheet of embodiment 3 reached 25 psi, the filtration sheet produced a total amount of about 933 L of water per unit area. From the beginning of the test, the filtration sheet maintained the turbidity removal efficiency close to 100% until the end of the test. By comparison with embodiment 1, the diameter and the gap diameter of the fiber in the fine filtration layer of embodiment 4 are less than those in embodiment 1, and the porosity of the fiber in the fine filtration layer of embodiment 4 is greater than that in embodiment 1. During the test, the filtration sheet had relatively slow increases in the pressure difference, and maintained high filtration efficiency. When the pressure difference between two sides of the filtration sheet of embodiment 4 reached 25 psi, the filtration sheet per unit area produced a total amount of about 520 L of water. In addition, from the beginning of the test, the filtration sheet maintained the turbidity removal efficiency close to 100% until the end of the test. The pre-filtration layer in comparative example 1 includes only one type of fiber. During the test, although the filtration sheet maintained high filtration efficiency (turbidity removal efficiency close to 100% was maintained from the beginning of the test until the end of the test), the pressure difference increased rapidly. When the pressure difference between two sides of the filtration sheet of comparative example 1 reached 25 psi, the filtration sheet per unit area produced only a total amount of about 160 L of water. Comparative example 2 is a melt-blown polypropylene multi-layer filtration sheet with a filtration level of 0.2 μm. During the test, the pressure difference of the filtration sheet increased rapidly, and an initial pressure difference was 8.1 psi, which was nearly twice initial pressure differences of embodiments 1, 3, and 4 and comparative example 1. The turbidity removal efficiency of the filtration sheet of comparative example 2 in the initial stage was 77%, which is not ideal. When the pressure difference between two sides of the filtration sheet of comparative example 2 reached 25 psi, the filtration sheet per unit area produced only a total amount of about 240 L of water. Comparative example 3 is a PES filtration sheet having a porous membrane structure and a filtration level of 0.2 μm. During the test, the pressure difference of the filter membrane structure increased rapidly, and the turbidity removal efficiency thereof at the initial stage was 94.5%. When the pressure difference between two sides of the filtration sheet of comparative example 3 reached 25 psi, the filtration sheet per unit area produced only a total amount of about 210 L of water.

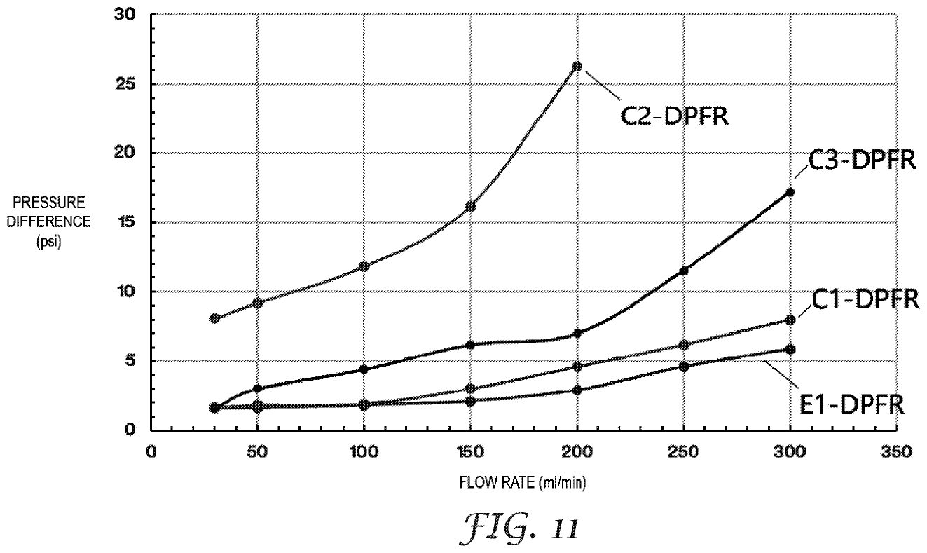

FIG. 11 shows performance regarding the pressure differences of filtration sheets having different structures at corresponding flow rates, equivalent to a flow rate-pressure difference test on various structures. The horizontal axis is the flow rate (ml/min), and the vertical axis is the pressure difference (psi). In FIG. 11, E1-DPFR represents the curve formed by pressure difference values of the filtration sheet prepared according to embodiment 1 corresponding to different flow rates. C1-DPFR represents the curve formed by pressure difference values of the filtration sheet prepared according to comparative example 1 corresponding to different flow rates. C2-DPFR represents the curve formed by pressure difference values of the filtration sheet prepared according to comparative example 2 corresponding to different flow rates. C3-DPFR represents the curve formed by pressure difference values of the filtration sheet prepared according to comparative example 3 corresponding to different flow rates. Upon comparison, the following can be learned: the filtration sheet including a fine filtration layer has a relatively small pressure difference, and comparative example 2 and comparative example 3 not including any fine filtration layer have a relatively large pressure difference. Therefore, the fine filtration layer has advantages in reducing the pressure difference of the filtration sheet and thereby extending the service life of the filtration sheet.

Although particular embodiments have been shown and described in the present invention, a person skilled in the art will understand that various alternative and/or equivalent embodiments can be used in place of the particular embodiments shown and described without departing from the scope of the present invention. The present application intends to include any improvement or modification for the specific embodiments discussed in the present invention. Accordingly, the present invention is subjected only to the claims and equivalents thereof.

It should be understood by a person skilled in the art that, various modifications and changes can be made without departing from the scope of the invention. Such modifications and changes are intended to fall within the scope of the invention as defined in the appended claims.

1. A laminated sheet used to perform water filtration, the laminated sheet comprising:
a pre-filtration layer, the pre-filtration layer comprising a first fiber having a diameter within a range of 1-5 μm and a second fiber having a diameter within a range of 200-900 nm, and the pre-filtration layer having a pore diameter within a range of 0.2-1 μm; and
a fine filtration layer, the fine filtration layer having a pore diameter within a range of 0.02-0.5 μm, wherein
the pore diameter of the pre-filtration layer is greater than the pore diameter of the fine filtration layer.

2. The laminated sheet used to perform water filtration according to claim 1, wherein the pre-filtration layer has a porosity within a range of 30-90%, and the fine filtration layer has a porosity within a range of 50-95%.

3. The laminated sheet used to perform water filtration according to claim 1, wherein with the total weight of the pre-filtration layer being 100 wt %, the first fiber accounts for 50-99 wt %, and the second fiber accounts for 1-50 wt %.

4. The laminated sheet used to perform water filtration according to claim 1, wherein the pre-filtration layer has a thickness within a range of 100-5000 μm.

5. The laminated sheet used to perform water filtration according to claim 1, wherein the pre-filtration layer has a grammage within a range of 10-120 g/m².

6. The laminated sheet used to perform water filtration according to claim 1, wherein the pre-filtration layer is prepared by means of one of or a combination of the following processes: melt blowing, carding, air laying, wet laying, and electrostatic spinning.

7. The laminated sheet used to perform water filtration according to claim 1, wherein the fine filtration layer comprises a third fiber having a diameter within a range of 10-200 nm.

8. The laminated sheet used to perform water filtration according to claim 1, wherein the fine filtration layer has a thickness within a range of 5-50 μm.

9. The laminated sheet used to perform water filtration according to claim 1, wherein the fine filtration layer has a grammage within a range of 0.5-5 g/m².

10. The laminated sheet used to perform water filtration according to claim 1, wherein the pre-filtration layer and the fine filtration layer are joined by means of one of or a combination of the following processes: hot calendering, ultrasonic welding, and bonding.

11. The laminated sheet used to perform water filtration according to claim 7, wherein the laminated sheet further comprises a support layer on a side of the fine filtration layer disposed away from the pre-filtration layer.

12. The laminated sheet used to perform water filtration according to claim 11, wherein the support layer comprises a fourth fiber having a diameter within a range of 2-50 μm.

13. The laminated sheet used to perform water filtration according to claim 11, wherein the support layer has a pore diameter within a range of 1-80 μm, and the pore diameter of the support layer is greater than the pore diameter of the pre-filtration layer.

14. The laminated sheet used to perform water filtration according to claim 12, wherein the first fiber, the second fiber, the third fiber, and the fourth fiber are prepared from materials respectively and independently selected from polyolefin, polyether, polyamide, polysulfone, polyester, fluoropolymer, polyacrylonitrile, polyurethane, polyvinyl alcohol, cellulose acetate, and a mixture or copolymer thereof.

15. A filter element used to perform water filtration, the filter element being formed by rolling the laminated sheet according to claim 11 into a shape of a cylinder, wherein the pre-filtration layer is located on an outer side of the cylinder, and the support layer is located on an inner side of the cylinder.

16. The filter element according to claim 15, wherein a wall of the cylinder is configured to be collapsible.

17. A cylindrical filter element used to perform water filtration, the cylindrical filter element, sequentially from the inside to the outside, comprising:
a cylindrical inner core; a cylindrical intermediate core, the cylindrical intermediate core being formed by rolling the laminated sheet according to claim 11, wherein: when the support layer is present, the pre-filtration layer is located on an outer side of the cylindrical intermediate core, and the support layer is located on an inner side of the cylindrical intermediate core; or, when the support layer is absent, the pre-filtration layer is located on the outer side of the cylindrical intermediate core, and the fine filtration layer is located on the inner side of the cylindrical intermediate core; and
a cylindrical outer core.

18. The cylindrical filter element used to perform water filtration according to claim 17, wherein the cylindrical inner core, the cylindrical intermediate core, and the cylindrical outer core contact each other.

19. A filtration kit used to perform water filtration, wherein the filtration kit accommodates the cylindrical filter element used to perform water filtration according to claim 17.

20. The cylindrical filter element used to perform water filtration according to claim 17, wherein the cylindrical inner core, the cylindrical intermediate core, and the cylindrical outer core contact each other.

21. A filtration kit used to perform water filtration, wherein the filtration kit accommodates the cylindrical filter element used to perform water filtration according to claim 17.
